(19) United States
(12) Patent Application Publication
(10) Pub. No.: US 2005/0239955 A1
(43) Pub. Date: Oct. 27, 2005

(54) Urethane acrylate composition structure

(75) Inventors: David J. Kielbasa, Oak Park, MI (US); Calvin T. Peeler, Canton, MI (US); David D. Peters, Wyandotte, MI (US); Joe C. Wilson, Woodhaven, MI (US)

Correspondence Address: BASF AKTIENGESELLSCHAFT, CARL-BOSCH STRASSE 38, 67056 LUDWIGSHAFEN, LUDWIGSHAFEN, 69056, DE

(73) Assignee: BASF Corporation.

(21) Appl. No.: 11/088,426

(22) Filed: Mar. 24, 2005

Related U.S. Application Data
(63) Continuation-in-part of application No. 10/832,903, filed on Apr. 27, 2004.
(63) Continuation-in-part of application No. 10/935,437, filed on Sep. 7, 2004.
(63) Continuation-in-part of application No. 10/935,549, filed on Sep. 7, 2004.

(51) Int. Cl. C08K 3/00

(52) U.S. Cl. 524/589

(57) ABSTRACT

A urethane acrylate composition includes a urethane acrylate adduct. The urethane acrylate adduct is the reaction product of an isocyanate component and a stoichiometric excess of a functionalized acrylate component. The functionalized acrylate component is reactive with the isocyanate component. The urethane acrylate composition also includes an inhibitor and a first metal salt. The inhibitor has a functional group that is sterically hindered. The urethane acrylate composition exhibits excellent stability over time. The presence of the inhibitor in combination with the metal salt improves the storage stability of the urethane acrylate composition.

### RELATED APPLICATIONS

This application is a continuation-in-part of co-pending U.S. patent application Ser. Nos. 10/832,903, 10/935,437, and 10/935,549, which were filed on Apr. 27, 2004, Sep. 7, 2004, and Sep. 7, 2004, respectively.

### FIELD OF THE INVENTION

The present invention generally relates to a urethane acrylate composition. More specifically, the urethane acrylate composition of the present invention exhibits excellent stability over time.

### BACKGROUND OF THE INVENTION

Urethane acrylate compositions are known in the art for including in coatings and structural composites. Urethane acrylate compositions include a urethane acrylate adduct that is the reaction product of an isocyanate component and a functionalized acrylate component that is reactive with the isocyanate component. The urethane acrylate compositions are generally produced by charging a reactor with a functionalized acrylate component and an isocyanate component and reacting these components at elevated temperatures, in excess of 60° C., for a sufficient amount of time to consume, or react, all free isocyanate groups of the isocyanate component.

Storage stability is often poor for the urethane acrylate compositions of the prior art. A urethane acrylate composition that demonstrates poor stability, i.e., one that is unstable upon storage, will typically separates into discrete layers, forms gels, or will form solids that may precipitate to the bottom of a container holding the urethane acrylate composition. Storage stability is important to avoid processing difficulties and inconsistencies in the coatings or structural composites produced from the urethane acrylate compositions resulting from separation within the urethane acrylate compositions. The prior art has included inhibitors in the urethane acrylate compositions to prevent unwanted polymerization of acrylate functionality during reaction of the functionalized acrylate component and the isocyanate component.

U.S. Pat. No. Re. 35,280 discloses a urethane acrylate composition including the reaction product of an isocyanate component and a functionalized acrylate component in the presence of hydroquinone, a non-sterically hindered inhibitor, and dibutyl tin dilaurate, a typical urethane catalyst. Although dibutyltin dilaurate may be considered a metal carboxylate, dibutyltin dilaurate does not dissociate into ions. However, due to the choice of inhibitors and an elevated reaction temperature in excess of 60° C., the inhibitor reacts with the isocyanate component. Thus, the inhibitor is consumed during the reaction between the isocyanate component and the functionalized acrylate component and is, therefore, not present in the final urethane acrylate composition. As a result, the urethane acrylate composition would be unstable over time. More specifically, the '280 urethane acrylate composition would develop visible separation and solids within a maximum of two weeks at about 20° C. and would form a solid gel shortly thereafter. The gelation is accelerated if the urethane acrylate composition is heated. Since urethane acrylate compositions are frequently stored for more than four weeks before use, the '280 urethane acrylate composition is not appropriate for many industrial applications. Further, HEMA can auto-polymerize at temperatures above 80° C. As a result, the examples described in the '280 patent can exhibit batch-to-batch variation in viscosity, potentially reducing storage stability, and potentially adversely impacting other material properties.

Likewise, U.S. Pat. No. 5,248,752 discloses a urethane acrylate composition including the reaction product of an isocyanate prepolymer based on a highly substituted pentanediol and hydroxyethyl methacrylate in the presence of an inhibitor, such as hydroquinone or phenothiazine, to prevent the polymerization of the hydroxyethyl methacrylate.

Although urethane acrylate compositions that include the inhibitor, as described above, achieve better storage stability relative to non-stabilized compositions, the storage stability is insufficient for applications that require the urethane acrylate compositions to be stored for more than a month before use. Due to the deficiencies of the prior art, including those described above, there remains an opportunity to further increase storage stability of such compositions to lengthen the time and temperature at which the compositions remain stable.

### SUMMARY OF THE INVENTION AND ADVANTAGES

The subject invention provides a urethane acrylate composition that includes a urethane acrylate adduct. The urethane acrylate adduct is the reaction product of an isocyanate component and a stoichiometric excess of a functionalized acrylate component that is reactive with the isocyanate component. The urethane acrylate composition also includes an inhibitor that has a functional group that is sterically hindered and a first metal salt.

The urethane acrylate composition exhibits excellent stability over time. More specifically, the presence of the inhibitor in combination with the metal salt drastically improves the storage stability of the urethane acrylate composition relative to compositions without the metal salt.

### DETAILED DESCRIPTION OF A PREFERRED EMBODIMENT

The subject invention provides a urethane acrylate composition that includes a urethane acrylate adduct. The urethane acrylate adduct is the reaction product of an isocyanate component and a functionalized acrylate component that is reactive with the isocyanate component. The urethane acrylate composition may be used in a wide variety of application areas including coating applications and, in particular, structural composites.

Depending on the intended use of the urethane acrylate composition, the isocyanate component may be selected from a wide variety of isocyanates including, but not limited to, aliphatic isocyanates, cycloaliphatic isocyanates, aromatic isocyanates, araliphatic isocyanates, isocyanate-capped quasi pre-polymers based on either aliphatic or aromatic isocyanates, other modified isocyanates not discussed herein, and combinations of any of those isocyanates. Preferably, the isocyanate component has at least two isocyanate groups, which provide polymeric functionality to the urethane acrylate adduct. In a more preferred embodiment, the isocyanate component has from two to three isocyanate groups.

Whenever the term aliphatic is used throughout the subject application, it is intended to indicate any combination of aliphatic, acyclic, and cyclic arrangements. That is, aliphatic indicates both straight chains and branched arrangements of carbon atoms (non-cyclic) as well as arrangements of carbon atoms in closed ring structures (cyclic) so long as these arrangements are not aromatic.

Suitable aliphatic and modified aliphatic isocyanates for the isocyanate component include, but are not limited to, hexamethylene diisocyanate (HDI), isophorone diisocyanate (IPDI) such as 1-isocyanato-3,3,5-trimethyl-5-isocyanatomethylcyclohexane, dicyclohexane-4,4′ diisocyanate (Desmodur W), hexamethylene diisocyanate trimer (HDI Trimer), isophorone diisocyanate trimer (IPDI Trimer), hexamethylene diisocyanate biuret (HDI Biuret), cyclohexane diisocyanate, meta-tetramethylxylene diisocyanate (TMXDI), and combinations thereof. Additionally, it is to be understood that the isocyanate component may be a pre-polymer based on, but not limited to, any of the aforementioned aliphatic isocyanates or derivatives.

Suitable aromatic isocyanates for use as the isocyanate component of the urethane acrylate adduct can be selected from, but are not limited to, the group of toluene diisocyanates such as 2,4- and 2,6-toluene diisocyanate and the corresponding isomeric mixtures, polymeric diphenylmethane diisocyanates, diphenylmethane diisocyanates such as 4,4′-, 2,4′-, and 2,2′-diphenylmethane diisocyanate and the corresponding isomeric mixtures, pre-polymers based on the aforementioned isocyanates, modified isocyanates and combinations thereof. Specific examples of suitable isocyanate components for the urethane acrylate adduct include, but are not limited to, Lupranate® M20S isocyanate, Lupranate® MI isocyanate, Lupranate® M70R isocyanate, Lupranate® M200 isocyanate, Lupranate® T-80 isocyanate and ELASTOFLEX® R23000 isocyanate. All are commercially available from BASF Corporation. As alluded to above, the isocyanate component may comprise a combination of isocyanates. That is, a blend of at least two isocyanates may be utilized for reaction with the acrylate component to form the urethane acrylate adduct.

Other suitable isocyanate components include, but are not limited to, alkylene diisocyanates with 4 to 12 carbons in the alkylene radical such as 1,12-dodecane diisocyanate, 2-ethyl-1,4-tetramethylene diisocyanate, 2-methyl-1,5-pentamethylene diisocyanate, 1,4-tetramethylene diisocyanate, 1,6-hexamethylene diisocyanate; cycloaliphatic diisocyanates such as 1,3- and 1,4-cyclohexane diisocyanate as well as any mixtures of these isomers, 2,4- and 2,6-hexahydrotoluene diisocyanate as well as the corresponding isomeric mixtures, 4,4′-2,2′-, and 2,4′-dicyclohexylmethane diisocyanate as well as the corresponding isomeric mixtures, as well as mixtures of any of the aforementioned isocyanate components.

A structural composite requiring UV stability is a primary example of an application area that would affect the selection of the isocyanate component. Parts that are directly exposed to sunlight or other sources of UV radiation tend to physically degrade or discolor if aromatic isocyanates are employed. Urethane acrylate adducts that are the reaction product of the aliphatic isocyanates are more stable to UV light than urethane acrylate adducts that are the reaction product of the aromatic isocyanates. Despite this, the isocyanate component may also include aromatic isocyanates. When the aromatic isocyanates are used, at least one UV performance-enhancing additive is preferably included such that the coatings or structural composites produced from the urethane acrylate composition demonstrate suitable stability under exposure to UV light. For coatings and structural composites formed from the urethane acrylate composition where UV stability is not critical, aliphatic isocyanates are not required. Other criteria that could affect the selection of the isocyanate component include, but are not limited to, a targeted heat distortion temperature, elongation, strength, hardness and other physical properties of the coatings or structural composites produced from the urethane acrylate composition that are not described herein.

The functionalized acrylate component includes at least one functional group that is reactive with at least one of the isocyanate groups of the isocyanate component. Preferably, the functionalized acrylate component has from one to four olefinic functional groups and from one to four isocyanate reactive functional groups. In a more preferred embodiment, the functionalized acrylate component includes a single isocyanate-reactive functional group and from one to four olefinic functional groups. In a most preferred embodiment, the functionalized acrylate component has one olefinic functional group and one functional group that is reactive with at least one of the isocyanate groups.

Preferably, the functional group that is reactive with at least one of the isocyanate groups is selected from the group of hydroxy-functional groups, amine-functional groups, and combinations thereof. Specific examples of functionalized acrylate components including suitable hydroxy-functional groups include hydroxymethyl, hydroxyethyl, hydroxypropyl, and hydroxybutyl acrylates and alkacrylates, and combinations thereof. In a preferred embodiment, the functionalized acrylate component also has an alkyl chain having from one to twenty carbon atoms. Specific examples of functionalized acrylate components including suitable alkyl chains include methacrylates, ethacrylates, propacrylates, butacrylates, phenylacrylates, methacrylamides, ethacrylamides, butacrylamides, and combinations thereof. It is to be appreciated that the acrylates and alkacrylates may include more than one of the aforementioned hydroxy-functional groups and may be incorporated as the poly-functional alcohol portion of the isocyanate-capped quasi prepolymer as described above.

Preferred functionalized acrylate components include hydroxymethyl methacrylate, hydroxyethyl methacrylate, hydroxypropyl methacrylate, hydroxymethyl ethacrylate, hydroxyethyl ethacrylate, hydroxypropyl ethacrylate, glycerol dimethacrylate, N-methylol methacrylamide, 2-tert-butyl aminoethyl methacrylate, dimethylaminopropyl methacrylamide, and combinations thereof. In a most preferred embodiment, the functionalized acrylate component is a hydroxyethyl methacrylate. It is to be appreciated that the functionalized alkylacrylates and functionalized acrylates may be used interchangeably, i.e., hydroxyethyl acrylate may be used in place of hydroxyethyl methacrylate and vice versa.

Alternatively, the urethane acrylate composition may include a reactive diluent other than the functionalized acrylate component primarily to further lower the viscosity of the resulting urethane acrylate composition. The reactive diluent has at least one acrylate-reactive unsaturated functional group selected from the group of vinyl, allyl, cyclic allyl, cyclic vinyl, acrylic, functionalized and non-functionalized acrylic, acrylamides, acrylonitrile, and combinations thereof. Specific examples of reactive diluents that are suitable for the subject invention include, but not limited to styrene, divinyl benzene, vinyl toluene, diacetone acrylamide, acrylonitrile, methyl methacrylate, hydroxyethyl methacrylate, hydroxypropyl methacrylate, alpha methyl styrene, butyl styrene, monochlorostyrene, diallyl phthalate and combinations thereof. When used, the reactive diluent is preferably added in an amount of less than or equal to 50 parts by weight, more preferably from 5 to 25 parts by weight, and most preferably from 7 to 15 parts by weight, based on the total weight of the urethane acrylate composition. Alternatively, a non-reactive diluent, as is known in the art, may be used. The non-reactive diluent is preferably added in an amount of from 5 to 10 parts by weight based on the total weight of the urethane acrylate composition.

The urethane acrylate composition further includes an inhibitor. Preferably, the inhibitor includes functional groups that are sterically hindered. Steric hinderance ensures that the functional groups of the inhibitor remain unreacted during the reaction between the isocyanate component and the functionalized acrylate component. The inhibitor is present to aid in the prevention of unwanted side reactions during the reaction between the isocyanate component and the functionalized acrylate component and to preserve the final urethane acrylate composition. Due to the steric hindrance of the inhibitor, the inhibitor is slow to react with the isocyanate component. As such, the functional group of the inhibitor remains unreacted during the reaction between the isocyanate component and the functionalized acrylate component, especially at reaction temperatures of less than 60° C. The preferred hindered inhibitors are described in further detail below. By remaining unreacted during the reaction between the isocyanate component and the functionalized acrylate component, the inhibitor is not consumed and is present in the final urethane acrylate composition. The presence of the inhibitor in the final urethane acrylate composition contributes to the excellent stability of the urethane acrylate composition.

Depending on the situation, the inhibitor more preferably includes a hindered phenol, a hindered amine, or a combination of the hindered phenol and hindered amine. For example, when a quick gel time of a layer formed from the urethane acrylate composition is desired, the hindered amine is preferred because the hindered amine accelerates cross-linking of the urethane acrylate composition, resulting in quick gelling of the layer. Conversely, in many structural composite manufacturing processes, slower gel times for the urethane acrylate composition are desirable to allow for cross-linking between the layers in the structural composites. Such cross-linking is difficult if the layers completely gel before formation of all of the desired layers. The hindered phenols promote slower gelling of the urethane acrylate compositions as compared to the hindered amines and are thus more preferred for the structural composite manufacturing processes that require slower gel times.

The hindered amines and hindered phenols are slower to react or are non-reactive with the isocyanate component relative to unhindered inhibitors such as hydroquinone. The rate of reaction can be attributed, in part, to the combination of the steric hindrance about the functional group and acidity of the functional group. Preferably, the hindered phenols suitable for the subject invention include a compound of the formula: 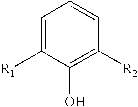
wherein R₁ and R₂ each comprise at least one of an aliphatic group having from one to twenty carbon atoms, an aromatic group having from one to twenty carbon atoms, and combinations thereof. Such an inhibitor is commonly referred to as a hindered phenol due to the presence of the R₁ and R₂ groups. Preferably, the hindered amines suitable for the subject invention include a compound of the formula: 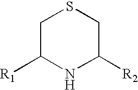
wherein R₁ and R₂ are as set forth above. The hindered phenol and hindered amine are less reactive with the isocyanate groups of the isocyanate component than unhindered phenols, such as p-methoxy hydroquinone (MEHQ), and unhindered amines. Reactivity of the hindered phenol and hindered amine may be reduced by maintaining the reaction temperature at less than 60° C.

The inhibitor may be combined with the functionalized acrylate component prior to the reaction between the functionalized acrylate component and the isocyanate component such that the inhibitor is present during the reaction without reacting with the isocyanate component or otherwise interfering with the production of the urethane acrylate composition. As a result, the inhibitor imparts excellent storage stability in the final urethane acrylate composition.

Specific examples of inhibitors that are suitable for the subject invention include, but are not limited to, a 3,5-bis-(1,1-dimethyl-ethyl)-4-hydroxy benzennepropanic ester of a C₁₄-C₁₅ alcohol blend, butylated hydroxytoluene, triethylene glycol-bis-3,3-t-butyl-4hydroxy-5 methyl phenyl propionate, pentaerythritol tetrakis [3-(3,5-di-tert-butyl-4-hydroxphenyl)propionate], octadecyl-3,5-di-(tert)-butyl-4-hydroxyhydrocinnamate, a 3,5-bis(1,1-dimethyl-ethyl)-4-hydroxy-C₇-C₉ branched alkylester, 2,2′-methylene-bis(6-t-butyl-4-methylphenol), 2,6-di-tertiary-butyl-4-nonylphenol, a butylated reaction product of p-cresol and dicyclopentadiene, tocopherol, phenothiazine, 2,2,4-trimethyl-1,2-dihydroquinolin, Naugard 445, Naugard PS 30, Irganox 5057, Irganox 565, Naugard 445, and combinations thereof.

Preferably, the inhibitor is present in the urethane acrylate composition in an amount of from 0.005 to 0.10 parts by weight based on the total weight of the urethane acrylate composition. More preferably, the inhibitor is present in an amount of from 0.01 to 0.05 parts by weight, most preferably from 0.025 to 0.035 parts by weight, based on the total weight of the urethane acrylate composition.

The urethane acrylate composition further includes a first metal salt comprising a metal carboxylate. Preferably, the metal carboxylate can dissociate into ions. An example of a preferred metal carboxylate is cobalt carboxylate. Cobalt carboxylate is commercially available from OMG America under the trade name 12% Cobalt Cem-all. Other metal carboxylates that may be suitable for the subject invention include cobalt naphthanate, cobalt hexanoate, and combinations thereof. Preferably, the first metal salt is present in the urethane acrylate composition in an amount of from 0.01 to 1.00, more preferably of from 0.05 to 0.75, and most preferably of from 0.10 to 0.50, parts by weight based on 100 parts by weight of the urethane acrylate composition.

The first metal salt lengthens the period over which the urethane acrylate composition remains stable. Without intending to be bound or limited by any particular theory, it is believed that the cobalt of the metal carboxylate coordinates to the carbamate nitrogen of the urethane acrylate, thus causing a defect in the packing structure of the molecules and limiting crystal formation and/or cross-linking reactions that result in the formation of gelled material within the urethane acrylate composition. A stable urethane acrylate composition indicates a urethane acrylate composition that, through visual observation, does not separate into discrete layers, has no precipitated solids either suspended in the urethane acrylate composition or forming a layer on the bottom of the container holding the urethane acrylate composition, and/or has no gelled material present, either suspended or precipitated. Conversely, an unstable urethane acrylate composition is either separated into discrete layers, has solids evident on the bottom of the container holding the urethane acrylate composition, has solids suspended in the urethane acrylate composition as indicated by an opaque and milky consistency that is visibly distinguishable from a stable urethane acrylate composition, which is colorless to brownish in color and transparent, or has formed gel material either suspended or precipitated or that is non-flowable within the container.

Although visual observation for separation and/or solids precipitation is convenient and sufficient for determining stability of the urethane acrylate, the viscosity of the urethane acrylate may also be used to determine when separation has taken place. More specifically, the viscosity of the urethane acrylate is measured over periodic time intervals. An increase in viscosity of greater than 10% over an original viscosity of the urethane acrylate indicates instability.

As a result of the presence of the inhibitor and the first metal salt in the urethane acrylate composition and the action of the inhibitor during the reaction between the isocyanate component and the functionalized acrylate component, the urethane acrylate composition is stable at a temperature 60° C. for a period of at least 100 days. As a general rule, for each decrease of 10° C., the number of days over which the urethane acrylate composition remains stable doubles. For example, the urethane acrylate composition of the subject invention would be expected to remain stable for a period of at room temperature of 25° C. for a period in excess of a year, which is a sufficient amount of time for many manufacturing processes. The length of storage stability is dependent on the concentration of the first metal salt. The concentration of the first metal salt is fixed by the targeted reactivity of the urethane acrylate, which is a function of the process requirements. The preferred concentration of the first metal salt in combination with the inhibitor for storage stability is 0.05 to 0.6 parts by weight based on the weight of the urethane acrylate composition and most preferred range is 0.2 to 0.4 parts by weight based on the weight of the urethane acrylate composition.

Preferably, the urethane acrylate composition also includes a peroxide-based catalyst. Without intending to be bound or limited by any particular theory, it is believed that the peroxide-based catalyst serves as a source of free radicals through an interaction with an accelerator, described further below. The free radicals generated allow polymerization to occur via a free-radical polymerization mechanism. Preferably the peroxide-based catalyst includes, but is not limited to, an organic peroxide. Specific examples of suitable peroxide-based catalysts include dibenzoyl peroxide, acetyl peroxide, benzoyl hydroperoxide, t-butyl hydroperoxide, di-t-butyl peroxide, lauroyl peroxide, butyryl peroxide, diisopropylbenzene hydroperoxide, cumene hydroperoxide, paramenthane hydroperoxide, diacetyl peroxide, di-alpha-cumyl peroxide, dipropyl peroxide, diisopropyl peroxide, isopropyl-t-butyl peroxide, butyl-t-butyl peroxide, difuroyl peroxide, bis(triphenylmethyl) peroxide, bis(p-methoxybenzoyl)peroxide, p-monomethoxybenzoyl peroxide, rubene peroxide, propyl hydroperoxide, isopropyl hydroperoxide, n-butyl hydroperoxide, t-butyl hydroperoxide, cyclohexyl hydroperoxide, trans-decalin hydroperoxide, alpha-methylbenzyl hydroperoxide, alpha-methyl-alpha-ethyl benzyl hydroperoxide, tetralin hydroperoxide, triphenylmethyl hydroperoxide, diphenylmethyl hydroperoxide, benzoyl peroxide, and combinations thereof. In addition, photo-initiated and azo-based catalysts may also be suitable.

Preferably, the urethane acrylate composition further includes a second metal salt. The second metal salt promotes a surface curing of the urethane acrylate composition during production of the structural composites. Without intending to be bound or limited by any particular theory, it is believed that the second metal salt interacts with the first metal salt, i.e., the cobalt carboxylate, to help promote a ligand exchange or a formation of a coordination complex in oxidative curing of the metal salt. Preferably, the second metal salt includes, but is not limited to, a metal carboxylate. Most preferably, the second metal salt includes potassium octoate and is commercially available from Air Products and Chemicals, Inc. of Allentown, Pa. under the trade name of DABCO® K-15. Preferably, the second metal salt is present in an amount of from 0.010 to 1.000, more preferably of from 0.025 to 0.500, and most preferably of from 0.050 to 0.250, parts by weight based on 100 parts by weight of the urethane acrylate composition.

Preferably, the urethane acrylate composition also includes the accelerator. Without intending to be bound or limited by any particular theory, it is believed that the accelerator forms a coordination complex with the second metal salt to increase a rate of peroxide decomposition, thus accelerating the free radical polymerization cross-linking in the urethane acrylate composition. Preferably, the accelerator is selected from the group of, but is not limited to, anilines, amines, amides, pyridines, and combinations thereof. However, other accelerators, such as acetylacetone, have also been contemplated for use in the subject invention. More preferably, the accelerator includes a dimethyl toluidine or a dialkyl aniline. Most preferably, the accelerator includes N,N-dimethyl-p-toluidine, N,N-diethylaniline, N,N-dimethylaniline, and combinations thereof. The most preferred accelerator is selected based on a desired gel time. N,N-dimethyl-p-toluidine is selected for fast gel times of less than 5 minutes. N,N-diethylaniline and N,N-dimethylaniline are selected for slower gel times of greater than 5 minutes. Preferably, the accelerator is present in an amount of from 0.01 to 0.50, more preferably of from 0.05 to 0.40, and most preferably of from 0.08 to 0.30 parts by weight based on 100, parts by weight of the urethane acrylate composition.

Depending on the selection of the peroxide-based catalyst, heat or other promotion techniques may also be used to promote and accelerate the initiation of the reaction. It is to be appreciated that other materials that function in combination with the above-mentioned metal salts and accelerators may also be used in the catalyst system.

Many urethane acrylate compositions have a high viscosity, making it difficult to use the urethane acrylate compositions in a spray application to produce the coatings or structural composites. The viscosity of the urethane acrylate compositions may be adjusted by varying the functionalized acrylate components according to the number of functional groups per functionalized acrylate component. More specifically, the amount of the functionalized acrylate component may be varied with respect to the isocyanate component while maintaining a stoichiometric excess of the functionalized acrylate component relative to the isocyanate component. The excess functionalized acrylate component functions as a reactive diluent for lowering the viscosity of the urethane acrylate composition. Preferably, the stoichiometric excess of the functionalized acrylate component is defined as a range of molar equivalent ratios of the functionalized acrylate component to the isocyanate component from 3:1 to 1.05:1. More preferably, the stoichiometric excess is defined as a range of molar equivalent ratios of from 2.5:1 to 1.05:1. In a most preferred embodiment, the stoichiometric excess is defined as a range of molar equivalent ratios of from 2:1 to 1.05:1. The actual amounts by weight of the functionalized acrylate component and the isocyanate component will vary depending on the specific acrylate or mixture of acrylates used, as well as with the specific isocyanate and/or isocyanate mixture used.

Preferably, the viscosity of the urethane acrylate composition is sufficiently low to enable spraying of the urethane acrylate composition during subsequent manufacturing processes; however, it is to be appreciated that the urethane acrylate composition may also be poured or injected, which may alter desired viscosity ranges for the urethane acrylate composition used in the processes. More specifically, the viscosity of the final urethane acrylate composition is preferably from 500 to 55,000 centipoise at 25° C., more preferably from 1,000 to 15,000 centipoise at 25° C., and most preferably from 2,000 to 2,800 centipoise, based on measurements on a Brookfield® RVT viscometer at 60 rpm using a number 3 spindle. For a typical spray application the viscosity of the unfilled urethane acrylate composition should be in a range of 300 to 1000 centipoise. If it is desired to add fillers, such as but not limited to calcium carbonate, to the urethane acrylate composition the viscosity of the unfilled urethane acrylate composition is preferred to be in the range of 150 to 300 centipoise. Once the filler is added to the urethane acrylate composition the viscosity can be further adjusted with reactive and non-reactive diluents, and/or heating the urethane acrylate composition to obtain the required viscosity for processing.

The following examples, illustrating the urethane acrylate composition, are intended to illustrate and not to limit the invention.

### EXAMPLES 1-5

A urethane acrylate composition of the subject invention is produced in a 5 liter, 4-necked round bottom flask. The flask is inspected, cleaned, and purged with air that is free of moisture. The flask is then charged with the functionalized acrylate component, the inhibitor, optionally the reactive diluent, the first metal salt, and a urethane catalyst such as dibutyltin dilaurate for the reaction between the isocyanate and isocyanate reactive acrylate components. Agitation is started using an agitator operating at about 250 rpm. The flask is cooled to a temperature of less than or equal to 20° C. The agitation is continued for about 15 minutes to dissolve and disperse the inhibitor in the functionalized acrylate component while maintaining a temperature of less than or equal to 20° C. in the flask. The isocyanate component is then fed into the flask over an isocyanate feed period. The temperature in the flask is maintained at or below a feed temperature while the isocyanate component is fed into the flask. Once all of the isocyanate component is fed into the flask, the reaction temperature is maintained within a reaction temperature range. A sample is taken from the flask at about 120 minutes after feeding of the isocyanate component into the flask is started. The sample is analyzed for remaining unreacted isocyanate groups by IR spectroscopy. If the sample includes unreacted isocyanate groups, the heating is continued with additional samples taken every 30 minutes until the reaction is complete. Once the reaction is complete, a 2-4 ounce sample is then taken from the flask to measure viscosity. The viscosity of the sample is measured on the Brookfield® viscometer at 25° C. The components and properties of Example 1 are indicated in Table 1 below, wherein all values are in parts by weight based on the total weight of the final urethane acrylate composition, unless otherwise indicated.

TABLE 1

| Component | Ex. 1 | Ex. 2 | Ex. 3 | Ex. 4 |
|---|---|---|---|---|
| Functionalized Acrylate | 66.06 | 66.04 | 66.00 | 65.94 |
| Component A | | | | |
| Inhibitor | 0.03 | 0.03 | 0.03 | 0.03 |
| Isocyanate Component A | 33.85 | 33.83 | 33.82 | 33.78 |
| Urethane catalyst | 0.05 | 0.05 | 0.05 | 0.05 |
| First Metal Salt | 0.01 | 0.05 | 0.10 | 0.20 |
| Total | 100.00 | 100.00 | 100.00 | 100.00 |
| Isocyanate Feed Period, Minutes | 60 | 60 | 60 | 60 |
| Reaction Time, Minutes | 420 | 420 | 420 | 420 |
| Feed Temperature, ° C. | 35 | 35 | 35 | 35 |
| Reaction Temperature Range, ° C. | 40-45 | 40-45 | 40-45 | 40-45 |
| Second Reaction Temperature, ° C. | 55 | 55 | 55 | 55 |
| Time Free From Separation at | 8 | 22 | 52 | >200 |
| 60° C. (Days) | | | | |

Functionalized Acrylate Component A is a 98% hydroxyethyl methacrylate (HEMA) solution, commercially available from Degussa.

Inhibitor is butylated hydroxytoluene (BHT).

Isocyanate Component A is a polymeric diphenylmethane diisocyanate (PMDI) with an actual functionality of approximately 2.7 and a NCO content of approximately 31.5 parts by weight, commercially available from BASF Corp.

Urethane Catalyst is dibutyltin dilaurate commercially available from Air Products and Chemicals, Inc.

First Metal Salt is 12% cobalt carboxylate commercially available from OMG America.

### COMPARATIVE EXAMPLE 1

Another urethane acrylate composition is produced absent the first metal salt in the 5 liter, 4-necked round bottom flask. The flask is inspected, cleaned, and purged with air that is free of moisture. The flask is then charged with the functionalized acrylate component, the inhibitor, and the urethane catalyst. Agitation is started using an agitator operating at about 250 rpm. The flask is cooled to a temperature of less than or equal to 20° C. The agitation is continued for between 30 and 60 minutes to dissolve and disperse the inhibitor and the urethane catalyst in the functionalized acrylate component while maintaining a temperature of less than or equal to 20° C. in the flask. The isocyanate component is then fed into the flask over an isocyanate feed period. The temperature in the flask is maintained at or below a feed temperature while the isocyanate component is fed into the flask. Once all of the isocyanate component is fed into the flask, the reaction temperature is maintained within a reaction temperature range. A sample is taken from the flask at about 120 minutes after feeding of the isocyanate component into the flask is started. The sample is analyzed for remaining unreacted isocyanate groups by IR spectroscopy. If unreacted isocyanate groups are present in the sample, the reaction is allowed to continue and additional samples are periodically taken every 30 minutes thereafter until the IR spectrum indicate that no unreacted isocyanate groups remain in the flask, as will be evidenced by the disappearance of the IR signal at about 2283 wave numbers. Once the reaction is complete, a 2-4 ounce sample is then taken from the flask to measure viscosity. The viscosity of the sample is measured on the Brookfield® viscometer at 25° C. The components and properties of the specific examples are indicated in Table 1 below, wherein all values are in parts by weight based on the total weight of the final urethane acrylate composition, unless otherwise indicated.

TABLE 2

| Component | Comp. Ex. 1 |
|---|---|
| Functionalized Acrylate Component A | 66.07 |
| Functionalized Acrylate Component B | 0.00 |
| Inhibitor | 0.03 |
| Urethane Catalyst | 0.05 |
| Isocyanate Component A | 33.85 |
| Isocyanate Component B | 0.00 |
| Isocyanate Component C | 0.00 |
| Isocyanate Component D | 0.00 |
| Total | 100.00 |
| Isocyanate Feed Period, Minutes | 30 |
| Reaction Time, Minutes | 240 |
| Feed Temp., ° C. | 45 |
| Reaction Temp. Range, ° C. | 35-40 |
| Viscosity, Cps | 2400 |
| Time Free From Separation at 60° C. (Days) | 5.5 |

Functionalized Acrylate Component A, Inhibitor, and Isocyanate Component A are the same as above in Example 1.

Functionalized Acrylate Component B is glycerin 1,3-dimethacrylate.

Urethane Catalyst is dibutyltin dilaurate commercially available from Air Products and Chemicals, Inc.

Isocyanate Component B is a hexamethylene diisocyanate trimer with an actual functionality of approximately 3.5 and a NCO content of approximately 21.6 parts by weight, commercially available from Bayer Corporation.

Isocyanate Component C is a diphenylmethane diisocyanate (MDI) with an actual functionality of approximately 2.0 and a NOC content of approximately 48.3 parts by weight based on the total weight, commercially available from BASF Corp.

Isocyanate Component D is toluene diisocyanate (TDI) with a functionality of approximately 2.0 and a NCO content of approximately 33.5 parts by weight, commercially available from BASF Corp.

The invention has been described in an illustrative manner, and it is to be understood that the terminology which has been used is intended to be in the nature of words of description rather than of limitation. Obviously, many modifications and variations of the present invention are possible in light of the above teachings, and the invention may be practiced otherwise than as specifically described.

1. A urethane acrylate composition comprising:
a urethane acrylate adduct that is the reaction product of:
an isocyanate component; and
a stoichiometric excess of a functionalized acrylate component that is reactive with said isocyanate component;
an inhibitor having a functional group that is sterically hindered; and
a first metal salt comprising a metal carboxylate.

2. A urethane acrylate composition as set forth in claim 1 wherein said metal carboxylate is selected from the group of cobalt carboxylate, cobalt naphthanate, and cobalt hexanoate.

3. A urethane acrylate composition as set forth in claim 1 wherein said metal carboxylate comprises cobalt carboxylate.

4. A urethane acrylate composition as set forth in claim 1 wherein said metal carboxylate is present in an amount of from 0.1 to 0.5 parts by weight based on the total weight of the urethane acrylate composition.

5. A urethane acrylate composition as set forth in claim 1 wherein said inhibitor comprises a hindered phenol.

6. A urethane acrylate composition as set forth in claim 5 that is visibly free from separation at a temperature of 60° C. for a period of at least 100 days.

7. A urethane acrylate composition as set forth in claim 5 wherein said hindered phenol comprises a compound having the formula: 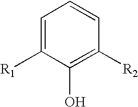
wherein R₁ and R₂ each comprise at least one of an aliphatic group having from one to twenty carbon atoms, an aromatic group having from one to twenty carbon atoms, and combinations thereof.

8. A urethane acrylate composition as set forth in claim 6 wherein said hindered phenol comprises butylated hydroxytoluene.

9. A urethane acrylate composition as set forth in claim 6 wherein said hindered phenol is selected from the group of a 3,5-bis-(1,1-dimethyl-ethyl)-4-hydroxy benzennepropanic ester of a C₁₄-C₁₅ alcohol blend, triethylene glycol-bis-3,3-t-butyl-4hydroxy-5 methyl phenyl propionate, pentaerythritol tetrakis [3-(3,5-di-tert-butyl-4-hydroxphenyl)propionate], octadecyl-3,5-di-(tert)-butyl-4-hydroxyhydrocinnamate, a 3,5-bis(1,1-dimethyl-ethyl)-4-hydroxy-C₇-C₉ branched alkylester, 2,2′-methylene-bis(6-t-butyl-4-methylphenol), 2,6-di-tertiary-butyl-4-nonylphenol, a butylated reaction product of p-cresol and dicyclopentadiene, tocopherol, and combinations thereof.

10. A urethane acrylate composition as set forth in claim 8 wherein said inhibitor further comprises a hindered amine selected from the group of phenothiazine, 2,2,4-trimethyl-1,2-dihydroquinolin, Naugard 445, Naugard PS 30, Irganox 5057, Irganox 565, Naugard 445 and combinations thereof.

11. A urethane acrylate composition as set forth in claim 1 wherein said inhibitor comprises a hindered amine.

12. A urethane acrylate composition as set forth in claim 11 that is visibly free from separation at a temperature of 60° C. for a period of at least 100 days.

13. A urethane acrylate composition as set forth in claim 11 wherein said hindered amine comprises a compound having the formula: 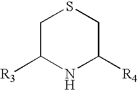
wherein R₃ and R₄ each comprise at least one of an aliphatic group having from one to twenty carbon atoms, an aromatic group having from one to twenty carbon atoms, and combinations thereof.

14. A urethane acrylate composition as set forth in claim 13 wherein said hindered amine is selected from the group of phenothiazine, 2,2,4-trimethyl-1,2-dihydroquinolin, Naugard 445, Naugard PS 30, Irganox 5057, Irganox 565, Naugard 445, and combinations thereof.

15. A urethane acrylate composition as set forth in claim 1 wherein said inhibitor is present in said urethane acrylate composition in an amount of from 0.005 to 0.10 parts by weight based on the total weight of said urethane acrylate composition.

16. A urethane acrylate composition as set forth in claim 1 wherein said inhibitor is present in said urethane acrylate composition in an amount of from 0.025 to 0.035 parts by weight based on the total weight of said urethane acrylate composition.

17. A urethane acrylate composition as set forth in claim 1 wherein said isocyanate component is selected from the group of aliphatic isocyanates, cycloaliphatic isocyanates, araliphatic isocyanates, aromatic isocyanates, isocyanate-capped quasi-prepolymers, modified isocyanates, and combinations thereof.

18. A urethane acrylate composition as set forth in claim 1 wherein said isocyanate component has at least two isocyanate groups.

19. A urethane acrylate composition as set forth in claim 1 wherein said isocyanate component is selected from the group of toluene diisocyanates, polymeric diphenylmethane diisocyanates, diphenylmethane diisocyanates, and combinations thereof.

20. A urethane acrylate composition as set forth in claim 18 wherein said isocyanate component comprises a prepolymer.

21. A urethane acrylate composition as set forth in claim 18 wherein said isocyanate component is selected from the group of hexamethylene diisocyanate, isophorone diisocyanate, dicyclohexane-4,4′ diisocyanate, hexamethylene diisocyanate trimer, isophorone diisocyanate trimer, hexamethylene diisocyanate biuret, cyclohexane diisocyanate, meta-tetramethylxylene diisocyanate, and combinations thereof.

22. A urethane acrylate composition as set forth in claim 18 wherein said functionalized acrylate component has at least one functional group that is reactive with at least one of said isocyanate groups.

23. A urethane acrylate composition as set forth in claim 22 wherein said functional group is selected from the group of hydroxy-functional groups, amine-functional groups, and combinations thereof.

24. A urethane acrylate composition as set forth in claim 23 wherein said functionalized acrylate component has from one to four olefinic functional groups and from one to four of said functional groups that are reactive with at least one of said isocyanate groups.

25. A urethane acrylate composition as set forth in claim 23 wherein said functionalized acrylate component has an alkyl chain having from one to twenty carbon atoms.

26. A urethane acrylate composition as set forth in claim 1 further comprising a peroxide-based catalyst.

27. A urethane acrylate composition as set forth in claim 26 wherein said peroxide-based catalyst comprises cumene hydroperoxide.

28. A urethane acrylate composition as set forth in claim 26 further comprising an accelerator selected from the group of anilines, amines, amides, pyridines, and combinations thereof.

29. A urethane acrylate composition as set forth in claim 28 wherein said accelerator is selected from the group of selected from the group of N,N-dimethyl-p-toluidine, diethyl aniline, dimethyl aniline, and combinations thereof.

30. A urethane acrylate composition as set forth in claim 26 wherein said peroxide-based catalyst comprises benzoyl peroxide.

31. A urethane acrylate composition as set forth in claim 30 further comprising an accelerator selected from the group of anilines, amines, amides, pyridines, and combinations thereof.

32. A urethane acrylate composition as set forth in claim 26 further comprising a second metal salt.

33. A urethane acrylate composition as set forth in claim 32 wherein said second metal salt comprises potassium octoate.

34. A urethane acrylate composition as set forth in claim 1 further comprising a reactive diluent.

35. A urethane acrylate composition as set forth in claim 1 having a viscosity of from 500 to 55,000 centipoise at 25° C.
